(19) United States
(12) Patent Application Publication
(10) Pub. No.: US 2023/0358628 A1
(43) Pub. Date: Nov. 9, 2023

(54) REALIZATION OF THE PASCAL FROM THE BOLTZMANN CONSTANT USING MASS COMPARISON OF ARTIFACTS IN VACUUM AND GAS

(71) Applicant: NATIONAL RESEARCH COUNCIL CANADA, Vancouver (CA)

(72) Inventors: Richard GREEN, Ottawa (CA); Nathan MURNAGHAN, Ottawa (CA)

(21) Appl. No.: 18/246,244

(22) PCT Filed: Sep. 21, 2021
(86) PCT No.: PCT/CA2021/051311

§ 371 Date: Mar. 22, 2023

Related U.S. Application Data
(60) Provisional application No. 63/082,193, filed on Sep. 23, 2020.

(51) Int. Cl. G01L 21/02; G01L 27/00

(52) U.S. Cl. CPC G01L 21/02; G01L 27/002

(57) ABSTRACT

The present disclosure relates to methods and systems for realization of a reference pressure as well as calibration of devices under test. The techniques leverage the measurement of buoyancy artifacts under vacuum and pressure conditions, and the use of gas law equations and related variables to obtain low uncertainty reference values for pressure among others. The techniques can include measuring an absolute mass difference of buoyancy artifacts under vacuum; measuring effective masses of the buoyancy artifacts under a gas pressure condition, and determining an effective mass difference between the buoyancy artifacts; and determining a low-uncertainty pressure based on the absolute mass difference, effective mass difference, Boltzmann constant, volume difference, molecular weight of the gas at pressure, and temperature of the measurements.

### TECHNICAL FIELD

The technical field generally relates to the realization of the Pascal and related realization methods in the area of metrology, particularly methods that utilize mass comparison of buoyancy artifacts in vacuum and gas environments.

### BACKGROUND

Pressure sensing instruments often need to be calibrated with traceability directly to the definition of the units of the Pascal, which is a derived unit given by kg m⁻¹ s⁻². In order to do so in practice to high accuracy, a reference pressure of known value must be produced whose value has been determined through measurements traceable to the realization of the base units. Presently, the unit can be realized using certain methods. One method involves a primary manometer that is usually mercury filled and produces a reference pressure traceable through the density of mercury, the displacement in height of the mercury containing cisterns with respect to each other, and gravity. Another method involves the use of a piston gauge through dimensional characterization of the piston and cylinder and mass as well as the acceleration due to gravity. Other methods involve optical interferometry. There are various challenges and drawbacks to known methods including the use of certain undesirable materials, modelling requirements, and other difficulties. There is a need for a technology that overcomes at least some of such challenges.

### SUMMARY

The present disclosure relates to methods and systems for realization of a reference pressure as well as calibration of devices under test. The methods and systems leverage the measurement of buoyancy artifacts under vacuum and pressure conditions, and the use of gas law equations and related variables to obtain low uncertainty reference values for pressure among others.

In some implementations, there is provided a method of realizing a low-uncertainty pressure unit, comprising: measuring an absolute mass difference of respective buoyancy artifacts under a vacuum condition, wherein the buoyancy artifacts have substantially the same nominal mass, substantially the same surface area, and different volumes defining a volume difference; measuring effective masses of the respective buoyancy artifacts under a gas pressure condition, and determining an effective mass difference between the buoyancy artifacts based on the effective masses; and determining the low-uncertainty pressure based on the absolute mass difference, the effective mass difference, the Boltzmann constant, the volume difference, the molecular weight of the gas at the pressure condition, and a temperature of the measurements.

In some implementations, the low-uncertainty pressure is determined based on a gas law equation. In some implementations, the gas law equation is the following:

$$p = \frac{{N}_{a} {k}_{b} T ( Δ {m}_{e , b} - Δ {m}_{b} )}{{M}_{g} Δ V}$$

wherein p is the pressure, k_{b} is the Boltzmann constant, M_{g} is the molar mass, T is thermodynamic temperature, ΔV is the volume difference, Δm_{b} is the mass difference between the two buoyancy artifacts at the vacuum condition, Δm_{e,b} is the mass difference between the two buoyancy artifacts at the gas pressure condition, and Nₐ is Avogadro's number.

In some implementations, the gas law equation is the following:

$$p = \frac{{N}_{a} {k}_{b} T ( Δ {m}_{e , b} - Δ {m}_{b} )}{{M}_{g} Δ V} R ( T )$$

wherein p is the pressure, k_{b} is the Boltzmann constant, M_{g} is the molar mass, T is thermodynamic temperature, ΔV is the volume difference, Δm_{b} is the mass difference between the two buoyancy artifacts at the vacuum condition, Δm_{e,b} is the mass difference between the two buoyancy artifacts at the gas pressure condition, R(T) is the temperature dependent real gas equation that expresses the deviation of the gas from non-ideality, and Nₐ is Avogadro's number.

In some implementations, the gas law equation comprises an expanded form of the gas law for real gases.

In some implementations, the gas pressure condition is provided using argon, air, hydrogen, helium, neon, xenon, a Noble gas, or an inert molecular gas, such as nitrogen or hexafluoride.

In some implementations, the gas pressure condition is from 0.1 Pa up to a gas-liquid or supercritical transition point of the gas.

In some implementations, the gas pressure condition is from 100 hPa to 2000 hPa or from 200 hPa to 1200 hPa. In some implementations, the vacuum condition is a vacuum pressure below 0.1 Pa, below 0.001 Pa, below 0.001 Pa or below 0.0001 Pa. In some implementations, the gas pressure condition is between 0.1 Pa and 1 Pa, and the vacuum condition below 0.0001 Pa or lower. In some implementations, the vacuum condition is a vacuum pressure sufficiently low to have a negligible buoyancy effect on the buoyancy artifacts.

In some implementations, the measuring of the absolute mass difference and the effective masses is performed in a same vessel. In some implementations, the vessel comprises a vacuum mass comparator.

In some implementations, the volume difference between the buoyancy artifacts is up to 1000 cm³. In some implementations, the volume difference between the buoyancy artifacts is above 10 L. In some implementations, the nominal mass of the buoyancy artifacts is 10 kg or less. In some implementations, the buoyancy artifacts are composed of austenitic stainless steel. In some implementations, determining the absolute mass difference and the effective mass difference between the buoyancy artifacts, is performed using a processor that receives information from a mass balance.

In some implementations, the determining of the low-uncertainty pressure is performed at a plurality of test conditions to generate a calibration curve, model or table.

In some implementations, the method further includes determining the molecular weight of the gas by chemical analysis and determination of relevant isotopic concentrations.

In some implementations, the method further includes determining the temperature by methods traceable to the definition of the Kelvin, or traceable to ITS90 with correction to thermodynamic temperature. In some implementations, the determining of the temperature comprises methods that include comparison directly with fixed points or comparison with sensors calibrated against fixed points.

In some implementations, there is provided a method of realizing a low-uncertainty pressure unit, comprising: measuring absolute masses and effective masses between buoyancy artifacts having substantially the same nominal mass, substantially the same surface area, and different volumes defining a volume difference; determining an absolute mass difference and an effective mass difference between the buoyancy artifacts; and determining the low-uncertainty pressure unit based on the absolute mass difference, the effective mass difference, the Boltzmann constant, the volume difference, a molecular weight of a gas used for generating the effective mass difference, and a temperature using at least one gas law equation.

In some implementations, there is provided a method of realizing a low-uncertainty molecular weight of a gas, comprising: measuring absolute masses of respective buoyancy artifacts under a vacuum condition, wherein the buoyancy artifacts have substantially the same nominal mass, substantially the same surface area, and different volumes defining a volume difference; determining an absolute mass difference between the buoyancy artifacts based on the absolute masses; measuring effective masses of the respective buoyancy artifacts under a gas pressure condition; determining an effective mass difference between the buoyancy artifacts based on the effective masses; measuring a pressure and a temperature of the system; and determining the low-uncertainty molecular weight of the gas based on the absolute mass difference, the effective mass difference, the Boltzmann constant, the volume difference, the pressure, and the temperature, using a gas law equation.

In some implementations, the pressure is measured using a manometer technique. In some implementations, the pressure is measured using a piston gauge technique. In some implementations, the temperature is measured using thermistors.

In some implementations, the gas law equation is as described above or herein.

In some implementations, the gas pressure condition is provided using argon, air, hydrogen, helium, neon, xenon, nitrogen or hexafluoride.

In some implementations, the gas pressure condition is from 0.1 Pa up to a gas-liquid or supercritical transition point of the gas.

In some implementations, the gas pressure condition is from 100 hPa to 2000 hPa.

In some implementations, the vacuum condition is a vacuum pressure below 0.1 Pa, below 0.001 Pa, below 0.001 Pa or below 0.0001 Pa, and is sufficiently low to have a negligible buoyancy effect on the buoyancy artifacts.

In some implementations, the measuring of the absolute mass difference and the effective masses is performed in a same vessel. In some implementations, the vessel comprises a vacuum mass comparator.

In some implementations, the volume difference between the buoyancy artifacts is up to 1000 cm³ or over 10 L.

In some implementations, the nominal mass of the buoyancy artifacts is 10 kg or less.

In some implementations, the determining of the low-uncertainty molecular weight is performed at a plurality of test conditions to generate a molecular weight calibration curve, model or table.

In some implementations, the method includes determining the temperature by methods traceable to the definition of the Kelvin, or traceable to ITS90 with correction to thermodynamic temperature. In some implementations, the determining of the temperature comprises methods that include comparison directly with fixed points or comparison with sensors calibrated against fixed points.

In some implementations, there is provided a method of realizing a low-uncertainty temperature of a system, comprising: measuring absolute masses of respective buoyancy artifacts under a vacuum condition, wherein the buoyancy artifacts have substantially the same nominal mass, substantially the same surface area, and different volumes defining a volume difference; determining an absolute mass difference between the buoyancy artifacts based on the absolute masses; measuring effective masses of the respective buoyancy artifacts under a gas pressure condition; determining an effective mass difference between the buoyancy artifacts based on the effective masses; measuring a pressure; determining a molecular weight of the gas; and determining the low-uncertainty temperature of the gas based on the absolute mass difference, the effective mass difference, the Boltzmann constant, the volume difference, the pressure, and the molecular weight of the gas using a gas law equation.

In some implementations, the pressure is measured using a manometer technique. In some implementations, the pressure is measured using a piston gauge technique.

In some implementations, the gas law equation is as described above or herein.

In some implementations, the gas pressure condition is provided using argon, air, hydrogen, helium, neon, xenon, nitrogen or hexafluoride.

In some implementations, the gas pressure condition is from 0.1 Pa up to a gas-liquid or supercritical transition point of the gas.

In some implementations, the gas pressure condition is from 100 hPa to 2000 hPa.

In some implementations, the vacuum condition is a vacuum pressure below 0.1 Pa, below 0.001 Pa, below 0.001 Pa or below 0.0001 Pa, and is sufficiently low to have a negligible buoyancy effect on the buoyancy artifacts.

In some implementations, the measuring of the absolute mass difference and the effective masses is performed in a same vessel. In some implementations, the vessel comprises a vacuum mass comparator.

In some implementations, the volume difference between the buoyancy artifacts is up to 1000 cm³ or over 10 L. In some implementations, the nominal mass of the buoyancy artifacts is 10 kg or less.

In some implementations, the determining of the low-uncertainty temperature is performed at a plurality of test conditions to generate a temperature calibration curve, model or table.

In some implementations, the method includes determining the molecular weight of the gas b by chemical analysis and determination of relevant isotopic concentrations.

In some implementations, there is provided a process of calibrating a pressure sensing device, comprising: connecting the pressure sensing device to a reference device used in the method or the system as defined above or herein to be in fluid communication therewith; providing gas pressure conditions in the reference device and the pressure sensing device; comparing pressure readings from the pressure sensing device with determined pressure reference values from the reference device; and adjusting or recording the deviation of the pressure sensing device for discrepancies between the pressure readings and the predetermined pressure reference values.

In some implementations, there is provided a process of calibrating a pressure sensing device using one or more of the low-uncertainty pressures determined according to the method or system as defined above or herein.

In some implementations, there is provided a calibrated pressure sensing device that has been calibrated according to the processes or the systems defined herein.

In some implementations, there is provided a pressure realization system for realization of the Pascal, comprising:
at least a pair of buoyancy artifacts having substantially the same nominal mass, substantially the same surface area, and different volumes defining a volume difference
a vacuum mass comparator that includes a chamber, a pump coupled to the chamber to provide vacuum conditions, and a mass balance capable of comparing at least the two buoyancy artifacts within the chamber.
a gas supply system coupled to the chamber for supplying a gas into the chamber to provide gas pressure conditions;
a processor that is operatively coupled to the vacuum mass comparator in order to receive data therefrom, the processor being configured to generate a pressure reference value based on:
   an absolute mass difference between the buoyancy artifacts measured by the vacuum mass comparator,
   an effective mass difference between the buoyancy artifacts measured by the vacuum mass comparator under the gas pressure conditions,
   the Boltzmann constant,
   the volume difference,
   the molecular weight of the gas at the pressure condition, and
   the real gas coefficients of the gas; and
   the temperature at the pressure condition.

In some implementations, the pump comprises a turbo pump. In some implementations, the gas supply system comprises a gas supply vessel comprising a regulator. In some implementations, the gas supply system comprises a mass flow controller downstream of the gas supply vessel. In some implementations, the vacuum mass comparator comprises a mass flow controller downstream of the pump and upstream of the chamber. In some implementations, the vacuum mass comparator comprises a gas conduit providing fluid communication between the chamber and the pump, and a valve coupled to the gas conduit. In some implementations, the valve is a vacuum gate valve. In some implementations, the processor is configured to determine the pressure based on a gas law equation selected from those described herein. In some implementations, the gas supply system is configured to provide argon or any other gas described herein as the gas. In some implementations, the gas supply system is configured to provide the gas pressure condition from 0.1 Pa up to a gas-liquid or supercritical transition point of the gas. In some implementations, the gas supply system is configured to provide the gas pressure condition between 100 hPa to 2000 hPa or between 200 hPa and 1200 hPa. In some implementations, the pump is configured to provide a vacuum pressure below 0.1 Pa, below 0.001 Pa, below 0.001 Pa or below 0.0001 Pa. In some implementations, the gas supply system is configured to provide the gas pressure condition is between 0.1 Pa and 1 Pa, and wherein the pump is configured to provide the vacuum condition below 0.0001 Pa. In some implementations, the pump is configured to provide a vacuum pressure sufficiently low to have a negligible buoyancy effect on the buoyancy artifacts. In some implementations, the volume difference between the buoyancy artifacts is up to 1000 cm³. In some implementations, the volume difference between the buoyancy artifacts is above 10 L. In some implementations, the nominal mass of the buoyancy artifacts is 10 kg or less. In some implementations, the buoyancy artifacts are composed of austenitic stainless steel. In some implementations, the processor is configured to generate a pressure calibration curve comprising a plurality of the reference pressures generated at respective gas pressure conditions. In some implementations, the processor is configured to receive data on the molecular weight of the gas generated by chemical analysis and determination of relevant isotopic concentrations. In some implementations, the processor is configured to receive data on the temperature generated by methods traceable to the definition of the Kelvin, or traceable to ITS90 with correction to thermodynamic temperature.

In some implementations, there is provided a pressure calibration system for calibrating a pressure sensing device, comprising:
at least a pair of buoyancy artifacts having substantially the same nominal mass, substantially the same surface area, and different volumes defining a volume difference
a vacuum mass comparator that includes a chamber, a vacuum pump coupled to the chamber, and two balances within the chamber for receiving the buoyancy artifacts;
a gas supply system coupled to the chamber for supplying a gas into the chamber to provide gas pressure conditions;
a coupling assembly for connecting the pressure sensing device to the chamber of the vacuum mass comparator to provide fluid communication therebetween so that the pressure sensing device and the chamber are capable of being exposed to a same pressure condition provided by the gas supply system;
temperature sensors for acquiring temperature data of the gas proximate to the buoyancy artifacts under the gas pressure conditions;
a processor that is operatively coupled to the temperature sensors in order to receive the temperature data therefrom, the processor comprising pre-determined information comprising:
   an absolute mass difference between the buoyancy artifacts based on absolute masses thereof measured by the vacuum mass comparator,
   the Boltzmann constant,
   the real gas coefficients of the working gas at the working temperature,
   the volume difference,
   the molecular weight of the gas at the pressure condition, and
the processor being configured to determine, at each gas pressure condition provided by the gas supply system, a corresponding reference pressure based on the pre-determined information as well as an effective mass difference between the buoyancy artifacts based on effective masses thereof measured by the vacuum mass comparator under the corresponding gas pressure condition and the temperature based on the temperature data; and optionally being configured to compare the reference pressures with respective pressure readings from the pressure sensing device at the gas pressure conditions to detect discrepancies and/or provide a target adjustment of the pressure sensing device based on detected discrepancy.

In some implementations, the pump comprises a turbo pump. In some implementations, the gas supply system comprises a gas supply vessel comprising a regulator. In some implementations, the gas supply system comprises a mass flow controller downstream of the gas supply vessel. In some implementations, the vacuum mass comparator comprises a mass flow controller downstream of the pump and upstream of the chamber. In some implementations, the vacuum mass comparator comprises a gas conduit providing fluid communication between the chamber and the pump, and a valve coupled to the gas conduit. In some implementations, the valve is a vacuum gate valve. In some implementations, the coupling assembly comprises a tube having a first end connectable to the pressure sensing device and a second end connectable to the vacuum mass comparator. In some implementations, the tube is connectable to a portion of a feed conduit that is in fluid communication with the pump and the chamber. In some implementations, the processor is configured to determine the pressure based on a gas law equation selected from one or more as described herein. In some implementations, the gas supply system is configured to provide argon as the gas or any other gas described herein. In some implementations, the gas supply system is configured to provide the gas pressure condition from 0.1 Pa up to a gas-liquid or supercritical transition point of the gas. In some implementations, the gas supply system is configured to provide the gas pressure condition between 200 hPa to 1200 hPa. In some implementations, the pump is configured to provide a vacuum pressure below 0.1 Pa. In some implementations, the pump is configured to provide a vacuum pressure below 0.001 Pa. In some implementations, the pump is configured to provide a vacuum pressure sufficiently low to have a negligible buoyancy effect on the buoyancy artifacts. In some implementations, the volume difference between the buoyancy artifacts is up to 1000 cm³. In some implementations, the volume difference between the buoyancy artifacts is above 10 L. In some implementations, the nominal mass of the buoyancy artifacts is 10 kg or less. In some implementations, the buoyancy artifacts are composed of austenitic stainless steel. In some implementations, the processor is configured to generate a pressure calibration curve, model or table that includes the reference pressures and the pressure readings from the pressure sensing device. In some implementations, the processor is configured to receive data on the molecular weight of the gas generated by chemical analysis and determination of relevant isotopic concentrations. In some implementations, the processor is configured to receive data on the temperature generated by methods traceable to the definition of the Kelvin, or traceable to ITS90 with correction to thermodynamic temperature. In some implementations, the system further includes a display unit coupled to the processor and configured to display the detected discrepancy.

In some implementations, there is provided a method of realizing a low-uncertainty property, comprising: measuring absolute masses of respective buoyancy artifacts under a vacuum condition, wherein the buoyancy artifacts have substantially the same nominal mass, substantially the same surface area, and different volumes defining a volume difference; determining an absolute mass difference between the buoyancy artifacts based on the absolute masses; measuring effective masses of the respective buoyancy artifacts under a gas pressure condition; determining an effective mass difference between the buoyancy artifacts based on the effective masses; measuring or determining two variables selected from a pressure of the system, a temperature of the system, and the molecule weight of the gas; and determining the low-uncertainty variable selected from the pressure, the temperature of the system, and the molecule weight of the gas, based on the absolute mass difference, the effective mass difference, the Boltzmann constant, the volume difference, and the two determined variables, using at least one gas law equation. In some implementations, this method includes one or more features as defined herein.

In some implementations, there is provided a method of determining real gas coefficients of a gas, comprising: measuring absolute masses of respective buoyancy artifacts under a vacuum condition, wherein the buoyancy artifacts have substantially the same nominal mass, substantially the same surface area, and different volumes defining a volume difference; determining an absolute mass difference between the buoyancy artifacts based on the absolute masses; measuring effective masses of the respective buoyancy artifacts under a gas pressure condition; determining an effective mass difference between the buoyancy artifacts based on the effective masses; measuring a pressure of the system using a mercury manometer, a piston gauge or a combination thereof; measuring a temperature of the system; determining a molecular weight of the gas; and determining the real gas coefficients of the gas based on the absolute mass difference, the effective mass difference, the Boltzmann constant, the volume difference, the pressure, the temperature, and the molecular weight of the gas using a gas law equation.

In some implementations, there is provided a process of calibrating a pressure sensing device, comprising:
connecting the pressure sensing device to a reference device that comprises:
   at least a pair of buoyancy artifacts having substantially the same nominal mass, substantially the same surface area, and different volumes defining a volume difference;
   a vacuum mass comparator that includes a chamber, a vacuum pump coupled to the chamber, and two balances within the chamber for receiving the buoyancy artifacts;
   a gas supply system coupled to the chamber for supplying a gas into the chamber to provide gas pressure conditions;
   a coupling assembly for connecting the pressure sensing device to the chamber of the vacuum mass comparator to provide fluid communication therebetween so that the pressure sensing device and the chamber are capable of being exposed to a same pressure condition provided by the gas supply system;
   temperature sensors for acquiring temperature data of the gas proximate to the buoyancy artifacts under the gas pressure conditions;
providing a gas pressure condition in the chamber of the reference device and the pressure sensing device;
at the gas pressure condition:
   obtaining the temperature data from the temperature sensors and an effective mass difference between the buoyancy artifacts based on effective masses thereof measured by the vacuum mass comparator;
   determining a reference pressure using a gas law model and based on:
      pre-determined information comprising an absolute mass difference between the buoyancy artifacts based on absolute masses thereof measured by the vacuum mass comparator, the Boltzmann constant, the real gas coefficients of the working gas at the working temperature, the volume difference, and the molecular weight of the gas at the pressure condition; and
      the effective mass difference between the buoyancy artifacts, and the temperature data on the temperature data; and
providing the reference pressure and a pressure reading from the pressure sensing device at the gas pressure condition.

In some implementations, the process further includes providing a plurality of different gas pressure conditions and, at each gas pressure condition obtaining the corresponding temperature data and effective mass difference, and determining the reference pressure; and providing the reference pressures and the corresponding pressure readings to show discrepancies therebetween. In some implementations, the process includes one or more further features as defined herein.

### BRIEF DESCRIPTION OF DRAWINGS

FIG. 1 is a process flow diagram of for the realization of a high-accuracy property, such as pressure, based on mass differences of buoyancy artifacts in vacuum and gas as well as the Boltzmann constant and other obtained variables, such as temperature and the molecular weight of the gas.

FIG. 2 is a perspective cut view of two example buoyancy artifacts with different volumes and substantially same surface areas.

FIG. 3 is a graph of the Boltzmann constant versus pressure for experiments and theoretical calculations.

FIG. 4 is a schematic of an example realization system.

FIG. 5 is a schematic of an example calibration system.

### DETAILED DESCRIPTION

Techniques described herein relate to methods and systems for the realization of the Pascal from the Boltzmann constant and using mass comparison of artifacts having different volumes in vacuum and pressurized gas environments. In some implementations, the method can be used to determine reference pressure with a low degree of uncertainty to facilitate the calibration of pressure measurement devices.

In brief, in one implementation of the technology, two artifacts having different volumes and relatively similar masses and surface areas can be weighed in vacuum conditions to determine the mass difference (Δm_{b}) and also under gas pressure conditions (Δm_{e,b}). Knowing the temperature of the system and the molecular mass of the gas, the pressure can be determined based on the Boltzmann constant, based on gas law equations such as the following:

$$p = \frac{{N}_{a} {k}_{b} T ( Δ {m}_{e , b} - Δ {m}_{b} )}{{M}_{g} Δ V}$$

In the above equation, p is the pressure, k_{b} is the Boltzmann constant, M_{g} is the molar mass of the gas, T is temperature, ΔV is the volume difference between the two artifacts, Δm_{b} is the mass difference between the two artifacts at the vacuum conditions and Δm_{e,b} is the mass difference between the two artifacts at the gas pressure conditions, and Nₐ is Avogadro's number. While the equation above is expressed assuming an ideal gas for simplicity, it can be expanded to accommodate real gas equations that model additional physical effects such as gas compressibility, heat capacity, and van der Waals forces. Some examples of these are the Virial model, Clausius model, Van der Waals model. The real gas form can be expressed as:

$$p = {nk}_{B} TR ( T ) \\ where : \\ n = \frac{{N}_{A}}{{M}_{g}} {ρ}_{g} = \frac{{N}_{A}}{{M}_{g}} \frac{( Δ {m}_{e , b} - Δ {m}_{b} )}{Δ V}$$

where N_{A} and ρ_{g} are the Avogadro's number and the gas density respectively, R(T) is the temperature dependent real gas equation that expresses the deviation of the gas from non-ideality, i.e., how gas density changes with pressure. As an example, for the Virial model R(T) can be expressed as:

R(T)=(1+R₂(T)n+R₃(T)n² . . . Rᵢ(T)nⁱ⁻¹)

where R₂(T), R₃,(T), Rᵢ(T) represent the second, third, and i^{th} temperature dependent Viral coefficients respectively, these coefficients are gas identity dependent.

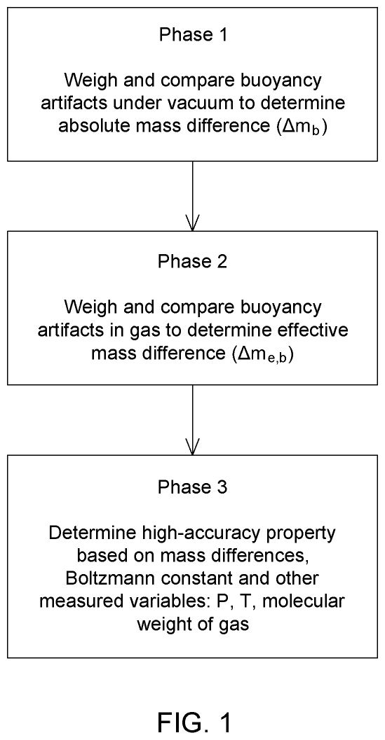

FIG. 1 shows a process flow diagram of an example realization method. In one implementation, the method is performed to realize the Pascal where pressure is the determined variable, as in the above equation. In this implementation, the other variables including temperature and molecular weight of the gas are measured variables that are input into the equation along with the volume difference and the difference between the absolute and effective mass differences of the buoyancy artifacts.

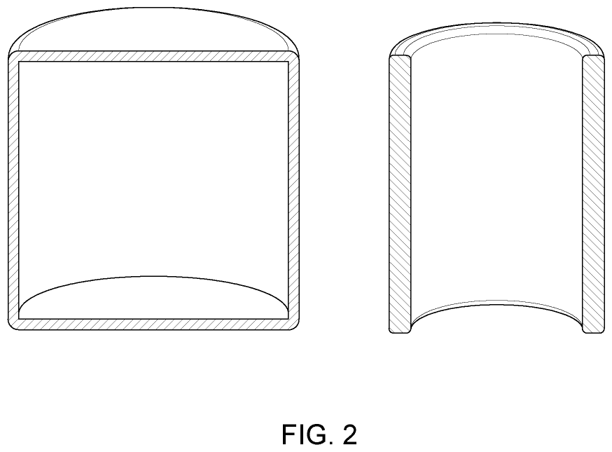

Turning to FIG. 2, an example pair of buoyancy artifacts is illustrated. One artifact is a hollow enclosed cylinder while the other is an open tube. The buoyancy artifacts are provided according to known methods and designed to minimize uncertainty effects that are well known in the field of metrology. The artifacts ideally having for example the same nominal mass, the same surface area and material of composition (to minimize sorption effects), and a large volume difference between the artifacts so as to maximize the sensitivity to gas density changes. It is noted that various types and designs of buoyancy artifacts can be used in the context of the present technology, and may have various shapes, sizes, forms, geometrical properties, masses, and the like, depending on factors such as the features of the equipment and instruments used in the realization method.

The present method facilitates direct realization of the pressure unit from the Boltzmann constant, which has the dimension energy divided by temperature and is recognized as one of the seven defining constants of the SI that have been given exact definitions. The Boltzmann constant is defined to be exactly 1.380649×10⁻²³ J·K⁻¹.

By comparing the relative weights of buoyancy artifacts—which can be considered mass artifacts of the same nominal mass, surface area and surface material and finish but of different volumes— the difference in buoyancy force acting on each of the artifacts can be determined when compared with their absolute mass difference which is their mass difference in vacuum. If the volume difference of the artifacts is known, then the density of the gas providing the buoyancy force can be determined to a very high degree of accuracy. Measurement of the gas density is a very useful quantity on its own, but combined with traceable measurements of the temperature of the gas and its molecular weight, the pressure of the gas can be determined from known gas laws (e.g., the virial expansion of the ideal gas law). If the measurements are performed first under vacuum within an enclosed vacuum comparator chamber, the absolute mass difference between the artifacts can be determined (see FIG. 1, phase 1). In the second phase, shown in FIG. 1, gas of known properties can be introduced into the chamber, and the measured mass difference between the buoyancy artifacts will change due to the difference in the quantity of gas displaced by the artifacts of different volume. The change in mass differences between the artifacts in the gas when compared to their difference in vacuum can be directly related to the gas pressure and the Boltzmann constant. This realized pressure can then be used as a reference to calibrate pressure sensing devices.

This novel technique enables realizing the unit Pascal through the Boltzmann constant using a system that can include vacuum mass comparator which compares buoyancy artifacts in vacuum and in a gas of known properties. There are several vacuum balances in use at National Measurement Institutes throughout the world and the techniques described herein could be tailored through modification of existing equipment and balances, or through the development of dedicated systems. This method can in principle reach accuracies competitive or lower than the other known methods listed above. In fact, the signal can be made arbitrarily large by increasing the volume difference between the buoyancy artifacts and/or increasing the molecular weight of the calibration gas, although there are limits on the potential gasses that could be used. In practice, the limiting uncertainties are likely to be temperature, molecular weight, and the uncertainty in the real gas coefficients of the calibration gas.

In some implementations, the method for the realization of the Pascal can include the following: measuring absolute masses of respective buoyancy artifacts under a vacuum condition, where the buoyancy artifacts have substantially the same nominal mass, substantially the same surface area, and different volumes defining a volume difference; determining an absolute mass difference between the buoyancy artifacts based on the measured absolute masses; measuring effective mass difference of the respective buoyancy artifacts under a gas pressure condition; and realizing the Pascal based on the absolute mass difference, the effective mass difference, the Boltzmann constant, the volume difference, the molecular weight of the gas at the pressure condition, and the temperature, using one or more gas law equations with measured or theoretical coefficients. This method can be used to generate one or more reference pressures that can, in turn, be compared to the pressure reading of a device under test in order to calibrate the device or provide a comparison in terms of pressure measurements.

The method can be implemented using a single vacuum mass comparator or similar vessel in which the buoyancy artifacts are weighed under the vacuum and gas pressure conditions. Alternatively, the buoyancy artifacts could be weighed in different chambers under the vacuum and gas pressure conditions, respectively, as long as any relevant differences between the chambers were accounted for. It is also noted that a variety of artifact structures, sizes, weights and types could be used; that various gases (e.g., Noble gas such as argon, air, and others) could be used as long as the gas is sufficiently characterized; and various system arrangements and equipment designs could be used to carry out the realization method. In terms of example gases that could be used, the following is a non-exhaustive list: air, argon, hydrogen, helium, neon, xenon, as well as inert molecular gases such nitrogen or sulfur hexafluoride.

In addition, once the realization method has been performed to realize the Pascal, the output can be used in a process for calibrating pressure sensing devices, each of which can be referred to as a device under test. The calibration process can include connecting a given pressure sensing device or devices to the chamber of the vacuum mass comparator to be in fluid communication, for example, under gas pressure conditions used for the realization method; comparing the readings from the pressure sensing device with one or more of the corresponding reference pressure values per the realization method; and then, if necessary, adjusting the pressure sensing device for discrepancies between the sensed and reference values or noting the differences to determine corrections. In some scenarios, the process includes multiple pressure conditions and generating a chart or table that provides the reference pressure and the test pressure reading at each pressure condition. The chart or table can then be used to make modifications to the electronics of the device under test and/or to make other corrections to the readings of the pressure sensing device.

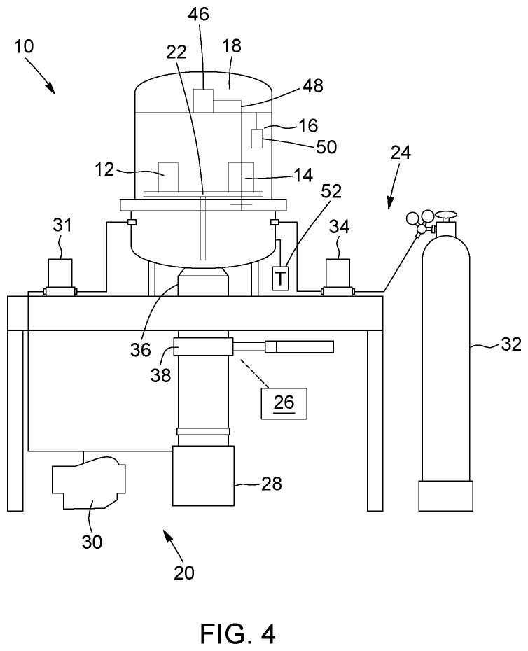

Referring to FIG. 4, the pressure realization system 10 for the realization of the Pascal can include a pair of buoyancy artifacts 12, 14; a vacuum mass comparator 16 that includes a chamber 18, a pump 20 coupled to the chamber to provide vacuum conditions, and a balance 22 that can compare at least two buoyancy artifacts 12, 14 such as via an automated mass handler. The balance 22 is housed within the vacuum chamber 18. The system 10 also includes a gas supply system 24 coupled to the chamber 18 for supplying a gas, such as argon, into the chamber 18 to provide gas pressure. The pressure realization system 10 can also include a processor 26 that is operatively coupled to the vacuum mass comparator 16 in order to receive certain data, such as the masses measured by the balances under vacuum and gas pressure conditions and other measured information.

Temperature sensors can be provided and configured to sense temperature of the gas as close as possible to the volume of gas that is displaced by the artifact. There may be multiple temperature sensors inside the chamber in areas around the displaced gas volume and the readings can be interpolated to approximate the target temperature sought. Temperature sensors can also be integrated into an artifact body on a different position of the mass handler which then samples the temperature at the necessary location, but does not need to be weighed accurately. In addition, a pressure sensor can be provided and can be used as a passive readout, or as an active gauge which provides feedback to the mass flow controllers to maintain constant pressure. The pressure sensor can be used to detect and account for pressure changes which could impact the calibration by controlling flow into the system. Thus, the pressure sensor could detect changes in pressure using a sensitive transducer, where a detected pressure change causes a signal to be sent to a mass flow controller to adjust gas flow. If pressure increases then the mass flow controller causes more gas to be exhausted to control the pressure in the experiment. The pressure transducer can be in communication with the chamber and arranged at the same height as the volume displaced by the artifacts. The pressure sensor can therefore provide pressure feedback for the realization and calibration methods.

Instrumentation and sensors can also be included in order to measure certain properties—such as temperature within the chamber, pressure, and other properties—and this information can also be provided to the processor 26. The processor 26 can also be configured to determine pressure values based on the measured mass differences and the Boltzmann constant, temperature, and properties of the gas such as molecular weight and its real gas model coefficients. If real gas coefficients are unknown, they may be determined by incorporating an accurate pressure sensing device. It is coupled to the chamber and real gas coefficients can be determined by varying pressures and measuring the mass difference. Deviations from an ideal gas will be observed that are characteristic of the working gas and can be used for future realization measurements. Still referring to FIG. 4, the pump 20 can include a high vacuum pump 28 and a backing pump 30, and there can also be a mass flow controller 31 downstream from the pump units. In addition, the gas supply system 24 can include a gas supply cylinder 32 with a regulator, and a mass flow controller 34. The system can also include a gas outlet 36 in which a high vacuum gate valve 38 is provided and operable between an open position when vacuum conditions are generated and a closed position when gas pressurizing conditions are provided. The system 10 can also include various conduits, which may be in the form of tubes, that enable fluid communication between certain components of the overall system. The connection points between tubes and vessels and other equipment can also be configured to provide a complete gas seal.

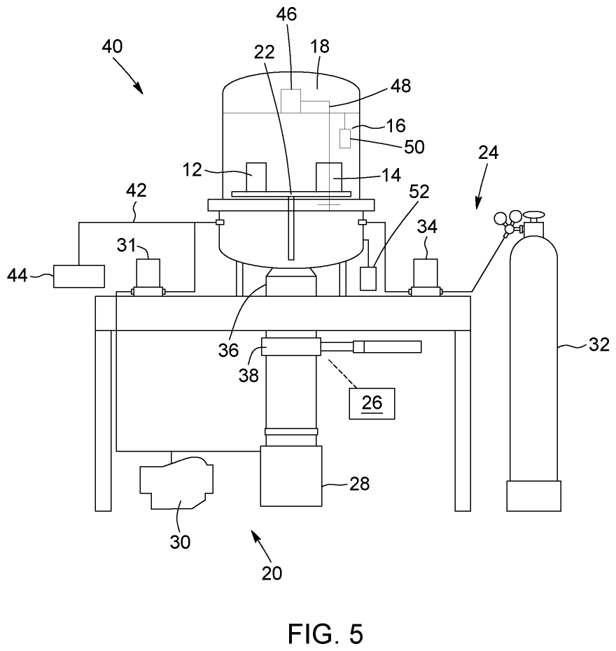

Referring to FIG. 5, a pressure calibration system 40 can include similar components as the pressure realization system 10 described above, with the addition of a gas connection member 42 that provides fluid communication between the chamber 18 of the vacuum mass comparator 16 and a pressure sensing device 44 to be calibrated. Once in fluid communication, the pressure calibration system 40 can be operated by providing gas under pressure into the chamber 18 at the same conditions as used to realize the Pascal and generate the calibration curve or model. The pressure reading of the pressure sensing device 44 can then be compared to the pressure determined via the realization methods and if a discrepancy is observed the pressure sensing device can be adjusted accordingly or the discrepancy can be recorded and provided for subsequent adjustments to the device under test.

Referring to FIGS. 4 and 5, the system can also include balance loadcell 46, weighing pan assembly 48, temperature probe 50 and temperature readout unit 52. Of course, there may be multiple temperature probes arranged in various ways in the chamber, and other components such as temperature readout unit can be included.

In practice, prior to initiating the calibration process, the system can be prepared and certain information can be obtained in advance. For instance, all of the input variables except for the gas temperature in the chamber and the effective mass different between the artifacts are known based on prior experiments using the system. Then, the device under test is put in fluid communication with the chamber so that it is exposed to the same pressure as the chamber and the two variables that are measured are the temperature and the effective mass difference of the artifacts. Those two variables are used in a gas law equation to determine the reference pressure, i.e., the realized pressure, which can in turn be compared to the pressure readout of the device under test at that pressure condition. In this way, multiple pressure conditions can be used to obtain a reference pressure and test-device pressure at each pressure condition.

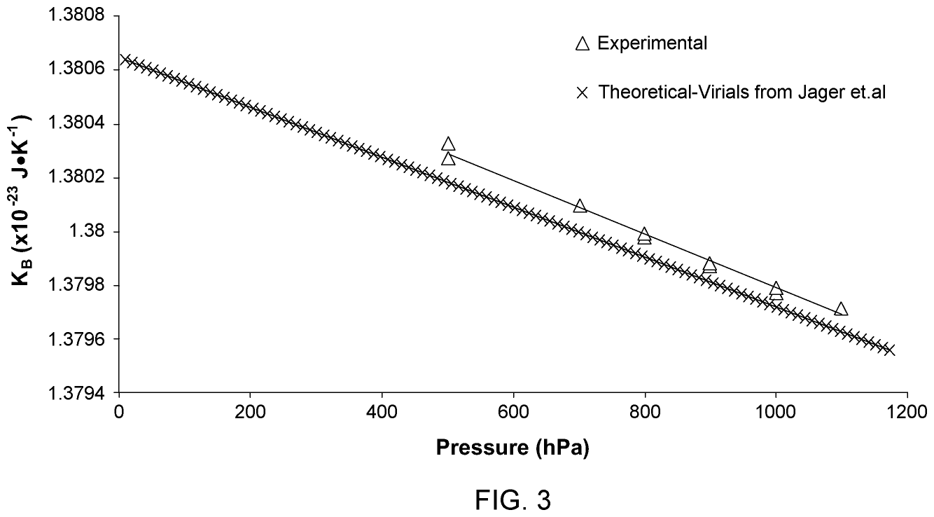

An understanding of the working gas can be obtained in various ways and may depend on the type of gas being used. The real gas coefficients and molecular weight of the working gas should be determined. For example, the real gas coefficients can be obtained by theoretical determination (e.g., see Jager et al.) or they could be measured (e.g., see slope of the line in FIG. 3). The molecular weight of the gas, where impurities are eliminated or accounted for, is also obtained and the same gas is ideally used for the calibration of the device under test. In addition to gas behaviour, its isotopic ratios should be known in order to account for the contribution to its molar mass, the relevant properties of the artifacts would also be known.

Regarding the pressure calibration range for this method, it is noteworthy that the pressure conditions can be continuous in the sense that different pressure conditions can be tested by simply increasing or decreasing the gas pressure in the chamber. This enables the possibility of testing at different pressures that are adjusted at very fine increments, if desired. In addition, the pressure range can be relatively broad with limits defined by the working gas and the equipment design. For instance, the upper pressure limit is related to the pressure at which the gas would undergo phase change into a liquid and the pressure limits of the equipment, which for some gases can be at relatively high pressures. The lower pressure limit can be related to the balance resolution and the vacuum pressure condition that is used to determine the absolute mass difference. For instance, if gas pressure measurements are desired around 0.1 Pa, then the vacuum pressure condition—also could also be called the zero pressure condition—would be a lower pressure, such as 0.00001 Pa, depending on the buoyancy force to obtain the right signal with the desired low uncertainty. Thus, the system could be designed for low and/or high pressure calibration applications.

In terms of operating parameters, the equipment used for the system as well as operating conditions (e.g., vacuum pressure, gas pressure, temperature) can be based on known techniques in the field of metrology. Depending on the instrumentation and equipment that are used, the operating conditions can be changed to achieve the desired low level of uncertainty for the pressure realization. For example, the vacuum conditions that are provided in the first phase of the method do not have to be absolute but can be sufficiently low such that the buoyancy effect is below a certain low level and is insignificant e.g., when the pressure is below 0.1 Pa. This vacuum can be provided by equipment such as a roughing pump backing a turbo pump or other appropriate means.

In another example, the balance for measuring the mass of the artifacts can have a dynamic range of 2 grams, and thus the artifacts and operating conditions should be designed such that the mass difference is within this 2-gram range over the course of the realization; but for balances with other dynamics ranges, the conditions and system components can be adapted accordingly.

In addition, to increase sensitivity of the realization, larger volume difference between the artifacts can be provided along with corresponding equipment sizing. When constrained by equipment size (e.g., size of the chamber of the vacuum mass comparator), then the volume difference can be maximized while staying small enough to be accommodated by the equipment.

While the implementations described and illustrated herein mainly focus on the realization of a reference pressure unit, it is also noted that other variables associated through the gas equations could be determined based on a similar methodology. For instance, instead of pressure, the gas density or temperature could be the variable that is determined, where pressure would be a known quantity used as an input variable. In this case, pressure could be determined via other realization methods such as through mercury manometer or dimensionally characterized piston gauge. As long as only one variable is unknown in the real gas equation during any given experiment, it may be determined via the measured apparent mass difference and the other known input variables. These other variables may be temperature, or molecular weight of the working gas, or the real gas coefficients of the working gas, or the volume difference of the buoyancy artifacts depending upon how the experiment is designed.

In another application of the methodology, the real gas coefficients could be determined when the temperature, pressure, and other relevant properties are known. For example, the pressure could be measured using another type of high-precision pressure sensing device, such as a mercury manometer or a piston gauge, with the other variables being measured or determined as per the description above, such that the real gas coefficients are the output variable from the selected gas law equation. This technique could be used to determine with high precision the real gas coefficients for a given working gas, which is then used in subsequent procedures for pressure realization using the methods described herein. For instance, in this way a mercury manometer could be used for limited experiments to determine the real gas coefficients of the working gas, and then the calibration methods described herein can then be used for calibration using that well-characterized working gas. Existing pressure realization devices, such as mercury manometers and piston gauges, can therefore be leveraged to provide low-uncertainty input information for the realization and calibration methods described herein.

In terms of applications of the technology, particular modifications and modules could be developed for existing systems (e.g., mass balance systems such as vacuum mass comparator systems) or dedicated systems could be developed. Dedicated systems that could be specially designed to calibrate pressure at the primary level could be used in National Measurement Institutes, high-level calibration laboratories, and the military. Pressure calibration is required by many branches of the military, particularly the air force, since altimeters are calibrated based on pressure to a high degree of accuracy. Addons could be systems to improve temperature control and homogeneity within the chamber to reduce uncertainty attributed to temperature, additional modules to provide and control the input and maintain improve the purity working gas and maintain and control pressure. The technology can be used in industries that rely on precision measurement of gases and the thermometry industry, for example. The technology facilitates the realization of pressure in a vacuum balance traceable to fundamental constants, and based on gas density with simultaneous gas density determination.

Benefits of implementations of the technology include the possibility of extremely high sensitivity, as the method scales with volume difference and molecular weight of the working gas; potentially wide measurement ranges; use of a main component that is a vacuum balance which exists in various NMIs worldwide; eliminating the need for mercury (Manometers), or dimensional characterization and modeling that are drawbacks of existing techniques.

### EXPERIMENTATION & RESULTS

Experiments were conducted to assess methods using the mass difference under vacuum and gas pressure and use this to determine the Boltzmann constant as a proof of concept test. In one series of experiments, two buoyancy artifacts were used. The artifacts were composed of austenitic stainless steel of 1 kilogram nominal mass having nominal volume difference of 410 cm 2, one having an enclosed tubular structure and the other having an open pipe structure. It is noted that other inert materials or coated materials can be used for the artifacts. The buoyancy artifacts were composed of the same material, had the same nominal mass and surface area, and yet had relatively different volumes. The buoyancy artifacts were placed on respective balance handler positions in the chamber of a vacuum mass comparator (Mettler Toledo Mone™) that includes a turbo pump for providing the vacuum. In an initial phase, the turbo pump is activated to create vacuum conditions in the chamber of approximately 1×10⁻⁴ Pa or lower, and the absolute mass difference was measured. In the next stage, with the turbo pump deactivated and the chamber closed, the vacuum mass comparator was coupled to an argon gas supply unit in order to supply a constant argon gas pressure in the chamber with the buoyancy artifacts remaining in the balance on their respective positions on the mass handler. The gas was obtained from a compressed gas cylinder (Praxair Argon™ 6N) and leaked into the chamber through a mass flow controller at a constant rate. Pressure was maintained at a nominal constant value by using the pressure signal from a high precision gauge (Paros Scientific™, accuracy of 0.01%) as feedback to control a second mass flow controller which exhausted the argon to a mechanical vacuum pump (Anest Iwata ISP250™) outside the measurement chamber. The argon was high purity to approximately 1 ppm, the purity of the gas was provided by the manufacturer in a lot analysis and secondary measurements were performed using a residual gas analyzer (MKS e-Vision 2™).

In addition, the temperature and the molecular weight of the argon gas were determined for the mass measurements. The temperature was measured via multiple 4 wire thermistor sensors read using a Fluke Blackstack™ readout, the thermistor readout system had been calibrated traceable to ITS90 and the values corrected to the thermodynamic temperature. The gas was selected to be of high purity and monitored in-situ for contamination. Literature values were used for the isotopic concentrations and resulting molecular weight of argon.

The effective mass differences of the artifacts were measured under various gas pressure conditions and used to calculate a value for Boltzmann constant (FIG. 3) based on equation (5) below. In this case, pressure used as input was traceable to traditional methods and used for a demonstration of comparability with an uncertainty of about 100 ppm. If argon were perfectly ideal gas the slope of Boltzmann value measured as a function of pressure should be 0. As argon is not perfectly ideal the experimental results demonstrate a slope that is expected and compared against a theoretical curve for which the Virial coefficients have been acquired from the literature (see Jager et. al., e.g., Eckhard Vogel, Benjamin Jager, Robert Hellmann & Eckard Bich (2010) Ab initio pair potential energy curve for the argon atom pair and thermophysical properties for the dilute argon gas. II. Thermophysical properties for low-density argon, Molecular Physics, 108:24, 3335-3352; as well as Benjamin Jager, Robert Hellmann, Eckard Bich, and Eckhard Vogel. Ab initio virial equation of state for argon using a new nonadditive three-body potential. The Journal of Chemical Physics 135:8). The intercept of the slope at P=0 for the calculated data is set to be the defined value of the Boltzmann constant. Based on these preliminary results, there was approximately 80-150 ppm agreement between experimental and expected results depending on the pressure value, but agreement within the total combined uncertainty of the measurements. There are experimental offsets and errors that have not yet been accounted for, including in pressure, temperature, flow effects and temperature gradients that require further exploration.

With the measured and determined variables, along with the Avogadro constant, the following equations (particularly equation 5 for this work) were used to calculate the Boltzmann Constant:

$$p = {nk}_{B} TR ( T ) \qquad ( 1 )$$

$$n = \frac{{N}_{A}}{{M}_{g}} {ρ}_{g} = \frac{{N}_{A}}{{M}_{g}} \frac{( Δ {m}_{e , b} - Δ {m}_{b} )}{Δ V} \qquad ( 2 )$$

$$p = \frac{{N}_{A} {k}_{B} T}{{M}_{g}} {ρ}_{g} \qquad ( 3 )$$

$$p = \frac{{N}_{a} {k}_{b} T ( Δ {m}_{e , b} - Δ {m}_{b} )}{{M}_{g} Δ V} \qquad ( 4 )$$

$${k}_{b} = \frac{{pM}_{g} Δ V}{{N}_{a} T ( Δ {m}_{e , b} - Δ {m}_{b} )} \qquad ( 5 )$$

The results were plotted and compared to a plot based on the Virial coefficients determined by Jager et. al, as shown in FIG. 3. Based on these preliminary results, there was approximately 80-150 ppm agreement. These preliminary results could be further improved with enhancements in terms of certain instrumentation and higher level calibration and the characterization of known offsets such as those due to temperature gradients, flow, and thermal expansion.

1.-137. (canceled)

138. A method of realizing a low-uncertainty property, comprising:
measuring absolute masses of respective buoyancy artifacts under a vacuum condition, wherein the buoyancy artifacts have substantially the same nominal mass, substantially the same surface area, and different volumes defining a volume difference;
determining an absolute mass difference between the buoyancy artifacts based on the absolute masses;
measuring effective masses of the respective buoyancy artifacts under a gas pressure condition;
determining an effective mass difference between the buoyancy artifacts based on the effective masses;
measuring or determining two variables selected from a pressure of the system, a temperature of the system, and the molecule weight of the gas; and
determining the low-uncertainty variable selected from the pressure, the temperature of the system, and the molecule weight of the gas, based on the absolute mass difference, the effective mass difference, the Boltzmann constant, the volume difference, and the two determined variables, using at least one gas law equation.

139. The method of claim 138, wherein the at least one gas law equation is selected from the following:
$$p = \frac{{N}_{a} {k}_{b} T ( Δ {m}_{e , b} - Δ {m}_{b} )}{{M}_{g} Δ V} R ( T ) ; or \\ p = \frac{{N}_{a} {k}_{b} T ( Δ {m}_{e , b} - Δ {m}_{b} )}{{M}_{g} Δ V} ;$$
wherein p is the pressure, k_{b} is the Boltzmann constant, M_{g} is the molar mass, T is thermodynamic temperature, ΔV is the volume difference, Δm_{b} is the mass difference between the two buoyancy artifacts at the vacuum condition, Δm_{e,b} is the mass difference between the two buoyancy artifacts at the gas pressure condition, R(T) is the temperature dependent real gas equation that expresses the deviation of the gas from non-ideality, and Nₐ is Avogadro's number.

140. The method of claim 138, wherein the gas pressure condition is provided using a Noble gas or an inert molecular gas.

141. The method of claim 140, wherein the gas pressure condition is from 0.1 Pa up to a gas-liquid or supercritical transition point of the gas.

142. The method of claim 138, wherein the measuring of the absolute mass difference and the effective masses is performed in the same vessel.

143. The method of claim 138, wherein determining the absolute mass difference and the effective mass difference between the buoyancy artifacts, is performed using a processor that receives information from a mass balance.

144. The method of claim 138, further comprising determining the molecular weight of the gas by chemical analysis and determination of relevant isotopic concentrations.

145. The method of claim 138, further comprising determining the temperature by methods traceable to the definition of the Kelvin, or traceable to ITS90 with correction to thermodynamic temperature.

146. The method of claim 138, wherein the low-uncertainty property is the Pascal and the two determined variables are the pressure of the system and the temperature of the system.

147. A pressure realization system for realization of the Pascal, comprising:
at least a pair of buoyancy artifacts having substantially the same nominal mass, substantially the same surface area, and different volumes defining a volume difference;
a vacuum mass comparator that includes a chamber, a pump coupled to the chamber to provide vacuum conditions, and a mass balance capable of comparing at least the two buoyancy artifacts within the chamber;
a gas supply system coupled to the chamber for supplying a gas into the chamber to provide gas pressure conditions;
a processor that is operatively coupled to the vacuum mass comparator in order to receive data therefrom, the processor being configured to generate a pressure reference value based on:
an absolute mass difference between the buoyancy artifacts measured by the vacuum mass comparator,
an effective mass difference between the buoyancy artifacts measured by the vacuum mass comparator under the gas pressure conditions,
the Boltzmann constant,
the volume difference,
the molecular weight of the gas at the pressure condition, and
the real gas coefficients of the gas; and
the temperature at the pressure condition.

148. The pressure realization system of claim 147, wherein the processor is configured to determine the pressure based on a gas law equation selected from:
$$p = \frac{{N}_{a} {k}_{b} T ( Δ {m}_{e , b} - Δ {m}_{b} )}{{M}_{g} Δ V} \\ or \\ p = \frac{{N}_{a} {k}_{b} T ( Δ {m}_{e , b} - Δ {m}_{b} )}{{M}_{g} Δ V} R ( T )$$
wherein p is the pressure, k_{b} is the Boltzmann constant, M_{g} is the molar mass, T is thermodynamic temperature, ΔV is the volume difference, Δm_{b} is the mass difference between the two buoyancy artifacts at the vacuum condition, Δm_{e,b} is the mass difference between the two buoyancy artifacts at the gas pressure condition, R(T) is the temperature dependent real gas equation that expresses the deviation of the gas from non-ideality, and Nₐ is Avogadro's number.

149. The pressure realization system of claim 147, wherein the gas supply system is configured to provide a Noble gas or an inert molecular gas as the gas.

150. The pressure realization system of claim 147, wherein the gas supply system is configured to provide the gas pressure condition from 0.1 Pa up to a gas-liquid or supercritical transition point of the gas.

151. The pressure realization system of claim 147, wherein the processor is configured to generate a pressure calibration curve comprising a plurality of the reference pressures generated at respective gas pressure conditions.

152. The pressure realization system of claim 147, wherein the processor is configured to receive data on the molecular weight of the gas generated by chemical analysis and determination of relevant isotopic concentrations.

153. The pressure realization system of claim 147, wherein the processor is configured to receive data on the temperature generated by methods traceable to the definition of the Kelvin, or traceable to ITS90 with correction to thermodynamic temperature.

154. The method of claim 138, wherein the low-uncertainty property is a low-uncertainty pressure unit and the two determined variables are the temperature of the system and the molecular weight of the gas at the gas pressure condition.

155. The method of claim 154, wherein the low-uncertainty pressure unit is the Pascal.
